(19) United States
(12) Patent Application Publication
(10) Pub. No.: US 2011/0140850 A1
(43) Pub. Date: Jun. 16, 2011

(54) REAL TIME TRACKING AND MONITORING OF GAS CYLINDERS

(75) Inventors: Kevin A. Wassel, Cedars, PA (US); Edward R. Coughlin, Horsham, PA (US)

(73) Assignee: Matheson Tri-Gas, Inc., Basking Ridge, NJ (US)

(21) Appl. No.: 12/967,870

(22) Filed: Dec. 14, 2010

Related U.S. Application Data
(60) Provisional application No. 61/286,992, filed on Dec. 16, 2009.

(51) Int. Cl. G06K 7/01; B65D 25/00; G08B 5/22; G01L 7/00

(52) U.S. Cl. 340/8.1; 220/724; 340/10.41; 73/700

(57) ABSTRACT

A gas cylinder transport cap is described. The cap has a bottom opening adapted for reversible attachment to a gas cylinder, where the attached cap surrounds a cylinder valve coupled to the gas cylinder. The cap also has a side surface which at least in part defines the perimeter of the bottom opening, where the side surface include a plurality of side openings; and a top surface formed on an opposite side of the cap from the bottom surface, where the top surface includes a top opening. The side openings and top opening improve transmissions of radio-frequency signals from a RFID device positioned inside the cylinder cap when the cap is attached to the gas cylinder. A method of tracking a gas cylinder transported between a first and second location is also described. The method may include the steps of coupling the gas cylinder to a RFID device, loading the gas cylinder on a transportation vehicle, and reading a gas cylinder identification signal transmitted by the RFID device with an RFID signal reader that translates the signal into gas cylinder identification data. The gas cylinder identification data may be associated with location data provided by a GPS device located in the transportation vehicle. The identification and location data may be communicated to gas cylinder tracking system that is remote from the transportation vehicle.

### CROSS-REFERENCES TO RELATED APPLICATIONS

This application is a nonprovisional of, and claims the benefit of the filing date of U.S. Provisional Patent Application No. 61/286,992, entitled “REAL TIME TRACKING AND MONITORING OF GAS CYLINDERS,” filed Dec. 16, 2009, the entire disclosure of which is incorporated herein by reference for all purposes.

### BACKGROUND OF THE INVENTION

Typically, the management of gas cylinder consumption within a manufacturing plant or a laboratory has been a manual process. Employees are tasked to identify the gas cylinders across a facility, transport them and also monitor the pressure for each gas cylinder attached to the device or process that consumes such gas. This manual process produces many inefficiencies, including lost cylinders, and lost time spent locating misplaced cylinders. But perhaps the greatest inefficiency occurs when a logistical breakdown results in a gas run-out during a lab experiment or as part of a manufacturing process. These gas run-outs could force plants to repeat analytical experiments, shut down critical manufacturing, and in some situations entire plants while additional gas is ordered and shipped. The resulting downtime causes substantial losses in productivity and revenue.

Because the productivity losses from gas run-outs can be so great, end-users will often pay additional costs to overstock gas cylinder products, and in some circumstances even pay for onsite cylinder management personnel provided by the gas supplier. Gas producers normally charge a cylinder rental fee for each gas cylinder delivered to the end-user, in addition to the gas purchase fee. These rental fees can accrue substantially when the end-user keeps more cylinders on site than is necessary to maintain plant operations. Moreover, stocking a greater number of cylinders increases the chances of a cylinder being lost, resulting in the end-user paying more cylinder replacement fees in addition to the accruing cylinder rental fees. End users face a constant challenge deciding how to determine the correct inventory of gas cylinders to keep on hand at additional cost to avoid the risk of a gas run-out and sustain plant operations.

End users make more effective decisions about the number of cylinders to stock when they have accurate, timely updates on the current levels of gas cylinder products being utilized and stocked on site. However, the more frequent these updates are required, the more resources that must be spent to gather and report the current gas cylinder inventory. In processes that require employees to manually monitor and report gas pressures for a large number of individual gas cylinder products, frequent updates can be a significant drain on worker resources and are prone to data recording and interpretation errors. Thus, there is a need for new solutions that provide for more frequent monitoring and reporting of gas product inventory in an end-user facility that also do not place a significant additional burden on the end-user's employees. There is also a need for new processes that reduce the number of gas cylinder products which must be inventoried in an end-user's facility without increasing the risk of a gas run-out that adversely affects facility operations. These and other issues are addressed by embodiments of the present invention.

### BRIEF SUMMARY OF THE INVENTION

Methods and systems are described that use Radio-Frequency Identification (RFID) technology to acquire gas cylinder location and gas consumption information in a real-time reporting basis for gas cylinders being stored and used within an end user's facility. These methods and systems address the performance limitations RFID technology has had to track and monitor gas cylinders due to signal attenuation problems when the RFID transceivers are in close proximity to metal cylinder parts. The methods and systems also address challenges integrating RFID with gas cylinders, including the integration of sensors to RFID tags (i.e., integrated RFID sensors) with an enclosure suitable to function within standard gas cylinder transport caps, battery power consumption, and the ability to securely and safely attach standard RFID tags to the various types of gas values used over a range of gas cylinder products, among other challenges.

The methods and systems described may include automatic sharing of RFID generated location and consumption information with a gas supplier to estimate when replacement gas cylinders should be ordered and shipped to the end-user's facility. These methods and systems allow frequent or even continuous updates of gas inventories at an end-user's facility without a corresponding drain on worker resources. These processes can also significantly reduce the risk of logistical errors and misinterpretation of gas data that may result in a gas run-out, thus permitting the end user to purchase, stock, and utilize the optimum number of gas cylinder products.

Methods and systems are also described for tracking and locating individual gas cylinders using RFID technology within a gas producer's plant, a storage facility, or an end-user facility, among other sites. These methods and systems provide real time information to track the location of gas cylinders transported between a gas producer facility where the cylinders are filled and an end-user's facility where the cylinders are discharged for storage or use. Providing gas cylinder location information in real time reduces the opportunities for a cylinder being lost or misplaced within an end-user's facility, transported to the wrong facility, or being accidentally removed from the facility.

One challenge with coupling RFID technology to gas cylinders is the large amount of RF shielding created by the metal used to make the gas cylinder components. Conventional high pressure cylinders are made from relatively thick layers of metal such as stainless steel, carbon steel, or aluminum. Similarly, many cylinder valves that control the release of gas from the cylinder are protected by a gas cylinder transport cap that prevents the valve from impact damage should the cylinder tip over or be mishandled or impacted in an inappropriate manner. The transport cap may be reversibly removed from the cylinder so the cylinder valve can be coupled to a cylinder filing device or end-user application after the cylinder is secured. The cap is also made of a relatively thick metal layer that heavily shields RF emissions. The shielding decreases the signal strength and signal propagation from an

RFID transmitter attached to the cylinder. These RF shielding problems that are associated with gas cylinders are addressed here with systems, devices, and cylinder designs that improve the transmission of RF signals without compromising the performance, safety, or integrity of the gas cylinder.

Another challenge is coupling RFID technology with sensors that monitor gas cylinder parameters such as, but not limited to: Cylinder pressure, liquid level, temperature, leak detection, and weigh. These integrated sensors may be used to measure gas levels and gas consumption inside the cylinder in real time. The RFID component may be used to broadcast cylinder measurement information in real time (or periodically updated time) through wireless electromagnetic signals. These signals are received and read by a compatible RFID reader station which is connected via a network system to a software application that interprets to a computer database or some other electronic information system. The received information may be processed and used for decision making events such as when to order a replacement gas cylinder. Systems and devices are also described for RFID integrated gas cylinder monitoring.

Specifically, embodiments of the invention include a gas cylinder transport cap. The cap has a bottom opening adapted for reversible attachment to a gas cylinder, where the attached cap surrounds a cylinder valve coupled to the gas cylinder. The cap also has a side surface which at least in part defines the perimeter of the bottom opening, where the side surface include a plurality of side openings, and a top surface formed on an opposite side of the cap from the bottom surface, where the top surface includes a top opening. The side openings and an optimally sized and placed top opening improve transmissions of radio-frequency signals from a RFID device attached directly to either the cylinder valve, cylinder neck area or cylinder shoulder area, and are positioned inside the cylinder cap when the cap is attached to the gas cylinder.

Additional embodiments of the invention may include gas storage and monitoring systems. The systems may include a gas cylinder for storing the gas where the gas cylinder includes a cylinder valve. The systems may further include a sensor fluidly coupled to the cylinder valve where the sensor detects at least one measured characteristic of the gas cylinder and generates cylinder information. The system may still further include an RFID device in electronic communication with the sensor and operable to transmit a wireless signal comprising the cylinder information. Embodiments may also include systems having a plurality of gas cylinders.

Still additional embodiments of the invention include methods of tracking and monitoring a gas cylinder attached to a gas delivery line without RFID devices installed on the body of the gas cylinder. These methods may include the use of an integrated gas line adapter coupled with RFID devices to provide a method of tracking and monitoring the location and pressure of a gas cylinder or group of gas cylinders, attached as a source of gas to a gas delivery line feeding a process or device. The identification and location data may be communicated to a gas cylinder tracking system that is remotely located from the location of the gas cylinders.

Further embodiments of the invention may include methods for tracking and monitoring gas cylinders that are utilized within a mobile manifold carriage in various configurations typically containing, but not limited to, about 4 to about 14 cylinders contained and configured within a single manifolded structural carriage assembly to deliver large volumes of gas to a process or device.

Still further embodiments of the invention include methods of tracking a gas cylinder transported between a first and second location. The methods may include the steps of coupling the gas cylinder to a RFID device, loading the gas cylinder on a transportation vehicle, and reading a gas cylinder identification signal transmitted by the RFID device with an RFID signal reader that translates the signal into gas cylinder identification data. The gas cylinder identification data may be associated with location data provided by a GPS device located in the transportation vehicle. The identification and location data may be communicated to gas cylinder tracking system that is remote from the transportation vehicle.

Yet more embodiments of the invention include methods of determining inventory usage of gas cylinders. The methods may include the step of measuring gas pressure in a gas cylinder with a sensor coupled to the gas cylinder. The gas pressure information about the gas cylinder may be transmitted using an RFID device in electronic communication with the sensor. The transmitted gas pressure information may be received at a gas cylinder tracking system, and the gas cylinder tracking system may calculate a time when the gas cylinder should be replaced.

Additional embodiments and features are set forth in part in the description that follows, and in part will become apparent to those skilled in the art upon examination of the specification or may be learned by the practice of the invention. The features and advantages of the invention may be realized and attained by means of the instrumentalities, combinations, and methods described in the specification.

### BRIEF DESCRIPTION OF THE DRAWINGS

A further understanding of the nature and advantages of embodiments of the invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIGS. 1A-B show a gas cylinder transport cap with surface openings for advancing and maintaining steady state signal propagation from RFID devices installed within the cylinder valve area of the cylinder according to embodiments of the invention;

FIG. 2 shows a gas cylinder valve with an integrated sensor device attached according to embodiments of the invention;

FIG. 3A shows an integrated RFID sensor technology coupled to a gas cylinder that transmits location and operating pressure data from a gas cylinder according to embodiments of the invention;

FIG. 3B shows the integrated RFID sensor technology positioned on the cylinder valve of the gas cylinder shown in FIG. 3A according to embodiments of the invention;

FIG. 4A shows an integrated RFID device attached to an in-line gas delivery adapter according to embodiments of the invention;

FIG. 4B shows another view of the integrated RFID device attached to the in-line gas delivery adapter in FIG. 4A;

FIG. 5A shows an integrated RFID device attached to a manifolded section of a mobile cylinder carriage according to embodiments of the invention;

FIG. 5B shows an RFID device attached to a gas cylinder contained within a mobile cylinder carriage according to embodiments of the invention;

FIG. 5C shows an RFID device attached to the structural frame of a mobile cylinder carriage that transmits the location of all gas cylinders contained within the mobile cylinder carriage and the location of the mobile cylinder carriage according to embodiments of the invention;

FIG. 6 shows a fastener mechanism used to secure an RFID device to a gas cylinder valve according to embodiments of the invention;

FIG. 7 is a flowchart with selected steps in a method of tracking a gas cylinder transported between a first and second location according to embodiments of the invention; and

FIG. 8 is a flowchart showing selected steps in a method of determining inventory and usage of gas cylinders according to embodiments of the invention.

### DETAILED DESCRIPTION OF THE INVENTION

Through the application of specialized sensor technology and supporting system hardware installed on pressurized gas containers within an active RFID technology environment, the acquisition of gas consumption data (and other gas attributes) can be facilitated and utilized for providing solutions to reducing supply chain management costs associated with purchasing pressurized gas containers including, but not limited to, order processing, delivery, manual labor and the acquisition and storage of gas products. Examples of methods, systems and equipment include:

### Exemplary Gas Cylinder Transport Caps

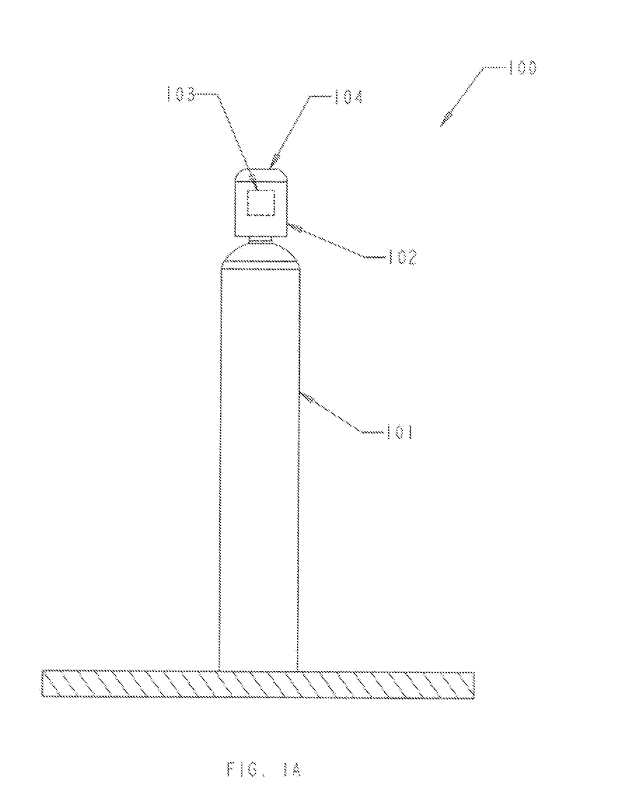

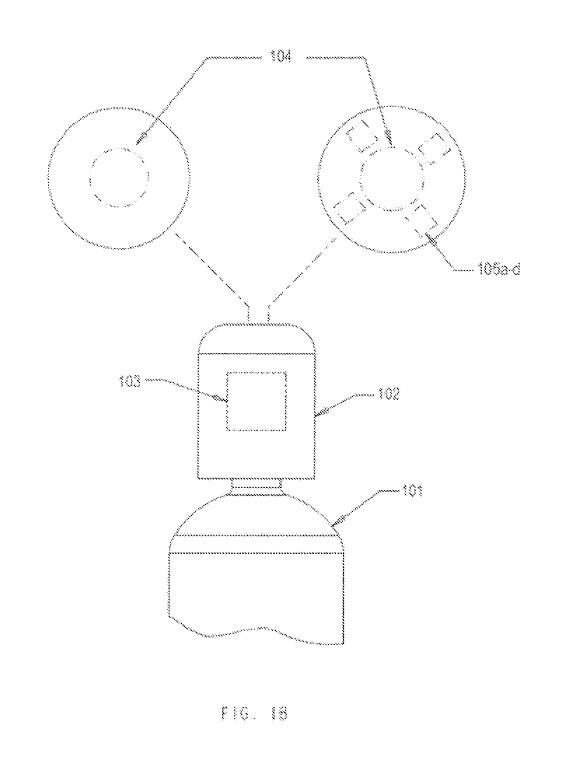

FIGS. 1A-B show a gas storage and monitoring system 100 that includes a gas cylinder transport cap 102 that is designed to maintain steady-state RFID signal propagation from an integrated RFID device 103 located inside cap 102 when it is secured to the top of gas cylinder 101. As shown in FIG. 1B, the top of the transport cap 104 may include one or more openings that reduce electrical interference with the transmission of RFID signals by the RFID device 103.

In the particular example shown in FIG. 1B, a plurality of four openings 105a-d are equally spaced 90° apart around the perimeter of the top of the transport cap 104. The openings 205a-d have a slightly rectangular shape. The embodiment shown in FIG. 1B also shows a circular opening at the center of the top of the transport cap 104.

The gas cylinder transport cap 102 may be formed to fit standard-sized treaded couplings on the top of a standard-sized gas cylinder. The cap 102 is also formed to accommodate holding the integrated RFID device 103 and any additional sensors and electronics inside the cap. The cap 102 is designed to conform with government safety and impact standards.

### Exemplary Gas Storage and Monitoring Systems

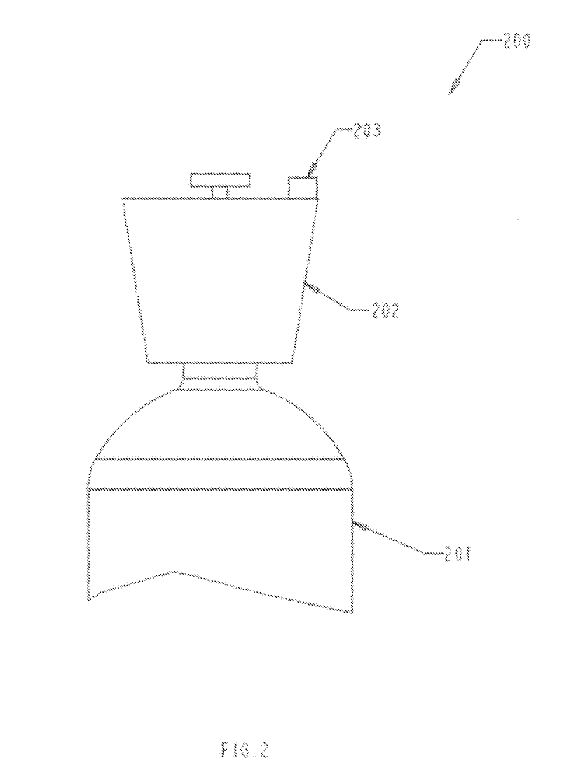

FIG. 2 shows the top portion of another gas storage and monitoring system 200 which includes an integrated RFID gas cylinder valve 202 and RFID device 203 for monitoring and transmitting information about the gas cylinder 201 and its contents. The integrated RFID gas cylinder valve 202 may include sensors that are fluidly coupled to the cylinder valve that measure and detect conditions in the gas cylinder 201 (e.g., pressure, temperature, etc., inside the gas cylinder). The sensors in cylinder valve 202 may be in electronic communication with the RFID device 203 to transmit information about the gas cylinder 201 to the device. The RFID device 203 may itself include integrated sensors and detectors that provide data about cylinder (e.g., the location of the cylinder).

The RFID device 203 may be operable to wirelessly transmit data signals representing information about the gas cylinder 201 collected from both the sensors in cylinder valve 202 and the RFID device 203 itself This information may include: a unique identifier for the gas cylinder, the location of the cylinder, and the pressure of the gas in the cylinder, and the type of gas in the cylinder, among other information. The information may be transmitted at a predetermined periodic interval (e.g., hourly, daily, weekly, monthly, etc.) and/or transmitted during an event such as moving the cylinder 201, opening or closing the cylinder valve, etc. In the additional embodiment, the information may be transmitted on a continuous or near continuous basis to monitor the condition of the gas cylinder 201 in real-time.

For an RFID device 203 that creates and transmits cylinder location data, the device 203 may include integrated electronics to receive and process signals from the Global Positioning System (GPS) or other positioning technology that allows the RFID device 203 to calculate and transmit the location of system 200. Incorporation of GPS technology permits near real-time tracking of the cylinder in transport. This tracking will become increasingly necessary as government regulations require it for an expanding group of potentially toxic, explosive, or otherwise hazardous gases.

The wireless signals transmitted by the RFID device 203 may be transmitted according to communication protocols containing specific amplitude and wavelength characteristics that improve signal propagation within the design and structural environment of a gas cylinder transport cap. The protocols facilitate the acquisition of data and continuous monitoring of the gas cylinders in multiple static and dynamic orientations in real-time using the gas cylinder transport cap, and also within environments that normally shield, reduce or limit signal propagation. This communication protocol may also allow the monitoring, acquisition, interpretation and non-interference of data generated from large groups of gas cylinders clustered together.

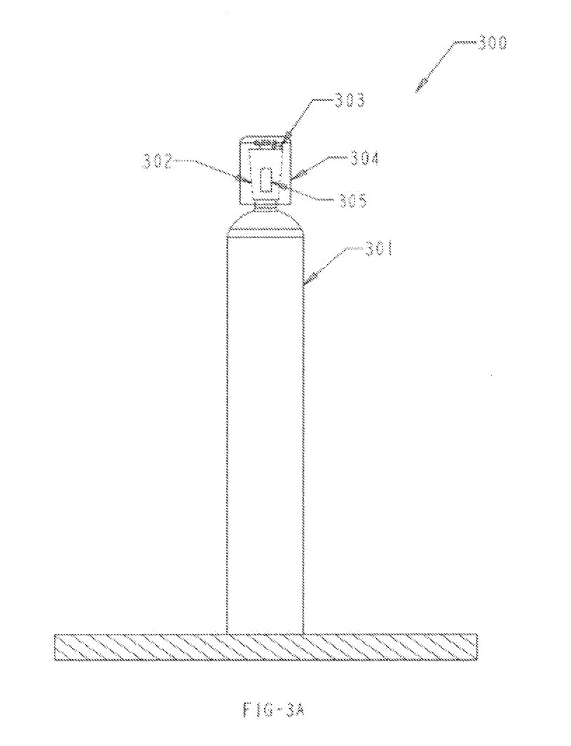

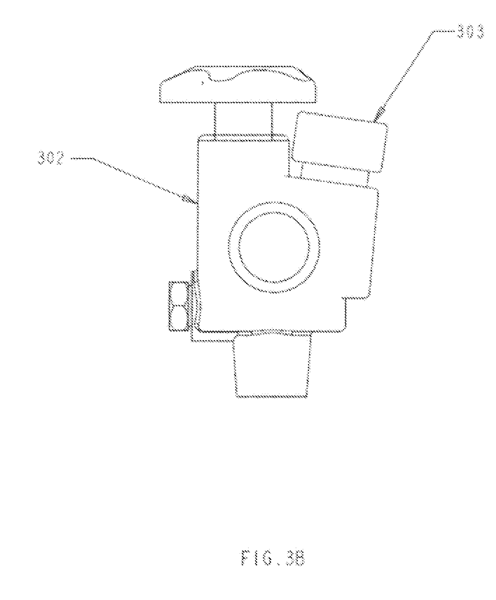

FIG. 3A shows another gas storage and monitoring system 300 which includes a gas cylinder transport cap 304 reversibly attached to gas cylinder 301. The attached cap 304 covers an integrated sensor cylinder valve 302 and RFID device 303 which are located proximate to the cylinder valve at the top of gas cylinder 301. The attached cap 304 may have one or more openings 305 formed on the side of the cap, as well as a top surface that includes one or more openings that reduce the interference with the wireless electric signals transmitted by integrated sensor cylinder valve 302 and/or the RFID device 303. The openings in the top of attached cap 304 may also be designed to reduce the interference with wireless electric signals received by the RFID device 303.

One or more sensors in valve 302 and/or the RFID device 303 may be operable to measure characteristics of the gas cylinder such as the pressure level of the gas in the cylinder, the temperature of the cylinder, and/or the location of the cylinder, among other characteristics. The sensors may be directly or indirectly in electronic communication with the RFID device 303 so that at least some of the measurement information collected by the sensors is electronically transmitted to the RFID device for wireless transmission. The sensors and RFID device 303 may form a single integrated device coupled to the cylinder valve.

FIG. 3B shows a close up view of an embodiment of the RFID device 303 that includes sensors that provide information on the condition of the gas cylinder 301. The RFID device 303 may be positioned adjacent to the cylinder valve 302 that controls the flow of fluids (e.g., gases) to and from the cylinder 301. The cylinder valve 302 and device 303 are positioned to fit inside a standard cylinder transport cap, such as cylinder transport cap 304. The RFID device 303 is designed to operate safely as an integrated assembly to facilitate the generation and transmission of wireless signals that may represent location data and other information about the gas cylinder 301. The body of cylinder valve 302 may incorporate planed, beveled and bored features that maintain the position of the sensors at rest within the valve body and may penetrate the cavity of the gas cylinder 301 to sense and acquire data about the contents of the cylinder (e.g., temperature, pressure, liquid level, moisture level, etc.). The combination of the cylinder valve 302 and RFID device 303 may be designed to incorporate a plurality of sensors to monitor the state of the gas cylinder and its contents.

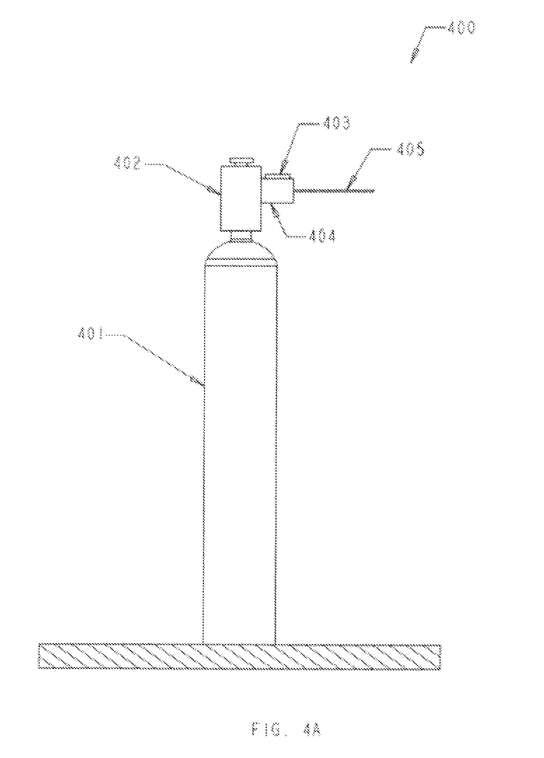

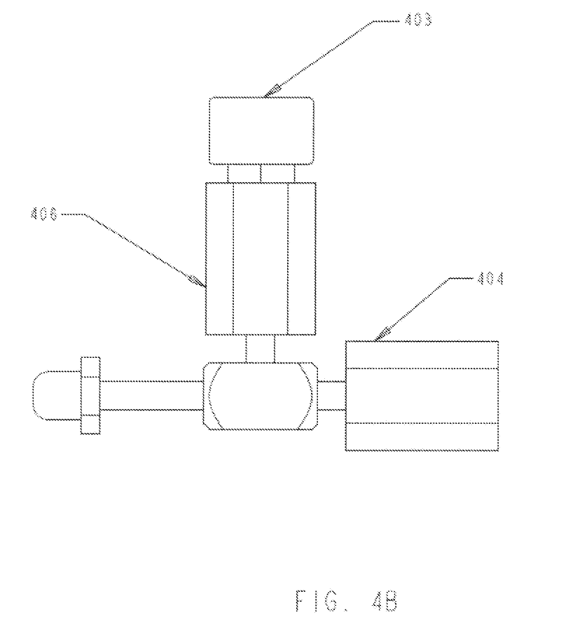

FIG. 4A shows another gas storage monitoring system 400 where the gas cylinder 401 is coupled to a gas delivery conduit 405 that delivers the gas from cylinder 401 to an end use application (not shown). The system 400 may include a cylinder valve 402 coupled to the gas cylinder 401. Coupled to the cylinder valve is an integrated sensor and RFID device 403. One or more sensors in the integrated device are operable to measure characteristics of the gas (or fluid) stored in the cylinder, such as gas pressure in the cylinder, gas temperature, and downstream gas pressure and flow rate of the gas released from the cylinder. The sensors are electronically coupled to the RFID portion of the device 403, which can wirelessly transmit data about the characteristics measured by sensors.

In the embodiment shown in FIG. 4A, the sensor and RFID device 403 are coupled to a gas delivery adapter 404 that allows the gas delivery conduit 405 to be leaktightly coupled to the gas stored in gas cylinder 401. The adapter 404 may be reversibly coupled to the cylinder valve on the gas cylinder 401, and may be selected to form a leaktight seal with the adjacent end of the gas delivery conduit 405.

As noted above, the RFID device 403 may be activated by the opening or closing of the cylinder valve and/or the release of gas from the gas cylinder 401. For example when the cylinder valve is opened, the RFID device 403 may start transmitting information about the time the valve was opened, the pressure of the gas in the cylinder, and the pressure and rate of flow of gas downstream of the cylinder valve, among other information. This information may be transmitted to, for example, a monitoring system (not shown) that may be operable to determine when the gas cylinder 401 should be replaced with a new cylinder.

Referring now to FIG. 4B, another view of the integrated sensor and RFID device 403 attached to the in-line gas delivery adapter is shown. In the configuration shown, the device 403 sits atop a transition assembly 406 that is orthogonally attached to the gas line adaptor 404. The transition assembly 406 may house one or more sensors used to collect information (e.g., pressure, flow rate, etc.) about the fluids passing through the gas line adaptor 404. These sensors may then transmit information electronically to the RFID device 403, which in turn may wireless transmit the information. Sensors may also be integrated directly into the RFID device 403 (e.g., a location sensor).

Exemplary Gas Storage and Monitoring Systems with Multiple Gas Cylinders

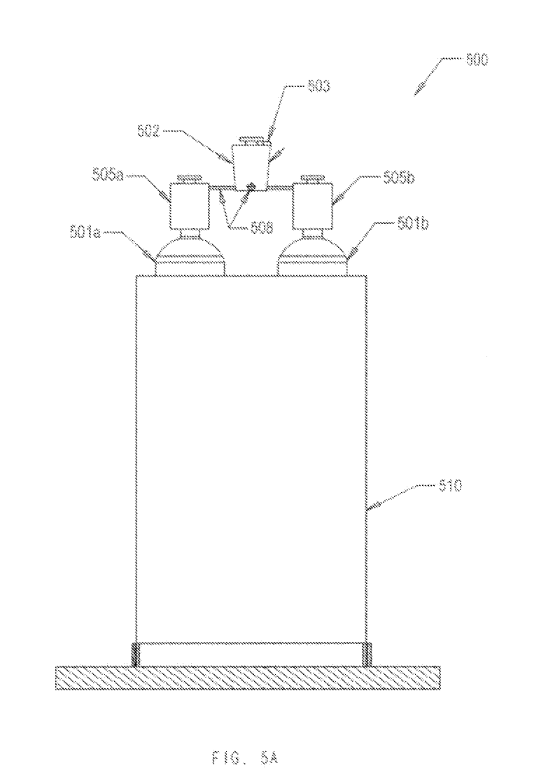

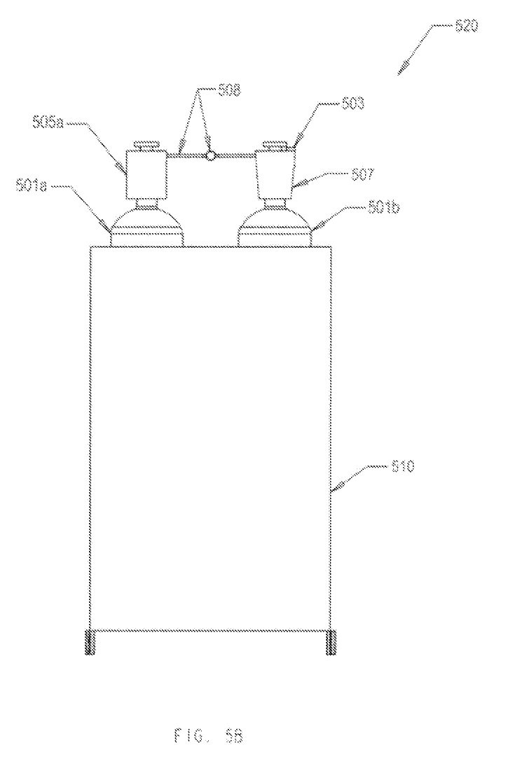

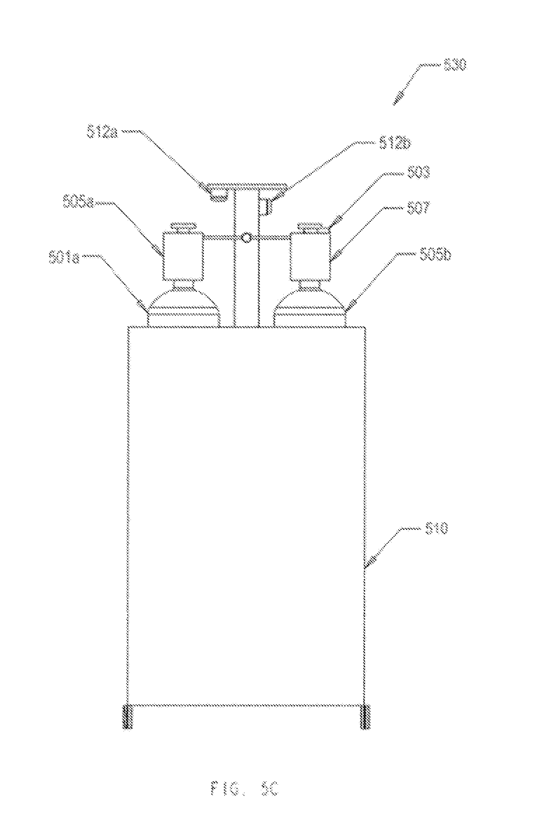

The systems described may also include systems that report information on the state of a plurality of gas cylinders from and RFID device. FIGS. 5A-C show some exemplary configurations for these multiple-cylinder systems. In embodiments of these systems the sensor and/or RFID devices may be positioned independently of some or all of the gas cylinders, thus eliminating the need to install these devices on each individual gas cylinder in the plurality of gas cylinders.

FIG. 5A shows a system 500 where a plurality of gas cylinders (501a-b) coupled to a centralized valve and sensor 502 that is in electronic communication with an RFID device 503. The cylinders 501a-b may be held in close proximity by a mobile cylinder carriage 510 that can move, transport, reposition, reorient, etc. the gas cylinders (501a-b) as a group.

Each of the individual gas cylinders 501a-b, may include a cylinder valve 505a-b that is fluidly coupled to a gas manifold 508 which directs the gases to the centralized valve and sensor 502. When either of the cylinder valves 505a-b are opened, measurements about the gases released from cylinders 501a and/or 501b, such as the pressure and/or flow rate of released gas, are obtained at the centralized valve and sensor 502. This and other information about the state of the gas cylinders 501a-b and carriage 510 (e.g., carriage location information) may be wirelessly transmitted by the RFID device 503. The centralized valve and sensor 502 may be configured to detect information about the gases supplied from each individual cylinder 501a-b, and/or may detect averaged information about the plurality of cylinders (e.g., the total pressure and/or flow rate measured at the centralized valve and sensor 502). The centralized valve 502 may control the supply of gas from the manifold to a end use application. For example, opening centralized valve 502 may cause a release of gases from some or all the gas cylinders 501a-b fluidly coupled to the manifold, and held in the mobile cylinder carriage 510. The sensor on the centralized valve and sensor 502 may detect the average gas pressure in the manifold and provide other information, such as location information about the carriage 510.

In additional embodiments, sensors in the centralized valve and sensor 502 may collect gas pressure and time data from each of the plurality of cylinders 501a-b and transmit the data via the RFID device 503. When one of the cylinders 501a-b falls below a threshold low pressure level, the RFID device 503 may transmit the pressure information and/or and alarm or alert indicating that the cylinder should be replaced. A sensor in the RFID device 503 may provide location data about the system 500 that is also transmitted by the RFID device.

FIG. 5B shows another embodiment of a system 520 where the plurality of gas cylinders 501a-b are coupled via the gas manifold 508. In this embodiment, there is no longer a centralized sensor that is independent of a particular gas cylinder. Instead the information about the plurality of cylinders 501a-b is collected at the integrated valve and sensor 507 attached to the cylinder valve on cylinder 501b and transmitted via RFID device 503 coupled to the sensor 507.

FIG. 5C shows still another embodiment of a system 530 where the plurality of gas cylinders 501a-b are coupled to a gas manifold. In this configuration, information about the gas cylinders and/or carriage 510 (e.g., location information about the carriage) may be transmitted by RFID devices 512a-b which are not coupled to any particular gas cylinder or sensor coupled to a gas cylinder valve. The RFID devices 512a-b may be positioned to allow wireless electronic signals to be sent and received with less interference from other components of the system 530. In the example shown, the RFID devices 512a-b are positioned on a post raised above the gas cylinders 501a-b and the mobile cylinder carriage 510. In some embodiments, an RFID device 512a-b may be present for each gas cylinder 501a-b present in the mobile cylinder carriage 510, and may transmit information about one associated gas cylinder. In other embodiments, a single RFID device may transmit the information about a plurality or all the gas cylinders grouped with the carriage 510.

While FIGS. 5A-C show two gas cylinders 501a-b being held by the mobile cylinder carriage 510, embodiments may include more than two gas cylinders. For example, the mobile cylinder carriage 510 may hold, three, four, five, six, seven, eight, nine, ten, twelve, fourteen, sixteen, etc., gas cylinders depending on the size of the cylinders and/or the carriage. The plurality of gas cylinders may be coupled via a gas manifold configured to keep the cylinders fluidly connected to a downstream destination, such as an application that consumes the gas.

### Exemplary RFID Fastening Mechanisms

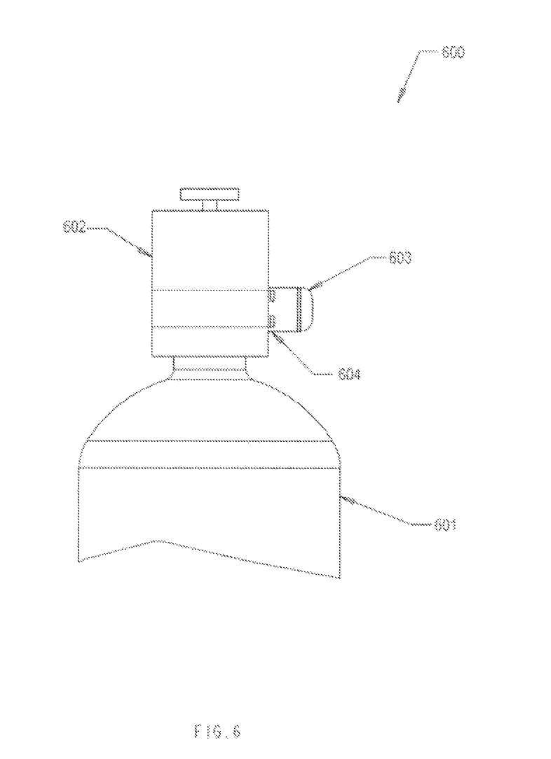

Turning to FIG. 6, an embodiment of a monitoring and storage system 600 is shown with a fastener mechanism 604 used to secure an RFID device 603 to a cylinder valve of a gas cylinder 601. The fastener mechanism 604 shown in FIG. 6 may include a strap that can be securely tightened around a sensor 602 attached to the cylinder valve of the gas cylinder 601. In the example shown, the strap can be reversibly secured to the RFID device 603, which permits its removal and replacement from the gas cylinder 601 without having to decouple the sensor 602 from the cylinder valve or gas cylinder 601 itself

Individual RFID devices 603 may be programmed to transmit information that uniquely identifies the attached cylinder, and may also be coupled to receive and transmit characteristics of the cylinder measured by sensor 602 (e.g., cylinder gas pressure, cylinder location, etc.). In some embodiments, the RFID device may act as a signal amplifier that receives a wireless signal transmitted from the sensor 602 or another RFID device coupled to the gas cylinder 601 and transmits an amplified signal containing at least a portion of the information received from the original signal.

### Exemplary Methods

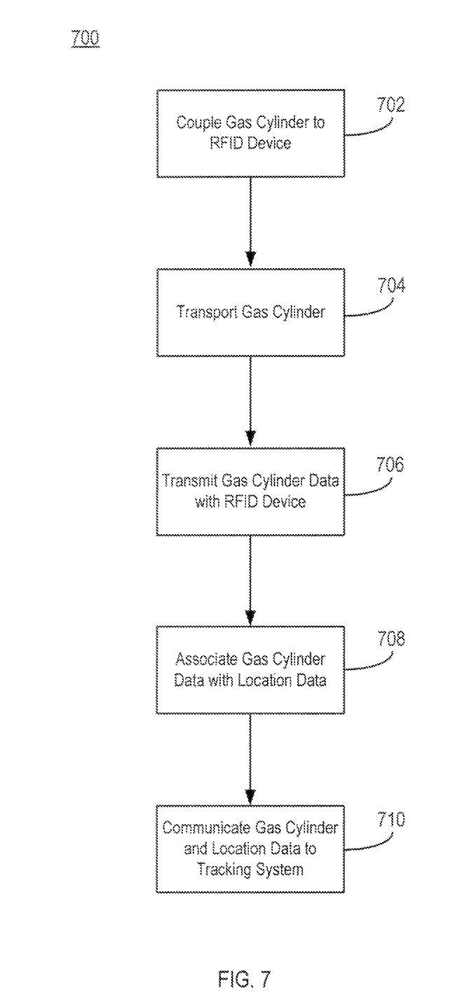

FIG. 7 is a flowchart with selected steps in a method 700 of tracking a gas cylinder transported between a first and second location. The method 700 may include the steps of coupling the gas cylinder to an RFID device 702 prior to transporting the gas cylinder 704. The RFID device may be coupled to the gas cylinder at the first location, which may be a facility to prepare gases and/or fill the gas cylinder with the stored gas. The first location may also be a storage site for storing the gas cylinders.

The method 700 may further include the step of transmitting gas cylinder identification data 706 through the RFID device. The identification data may include an alpha-numeric series of numbers, letters, and/or indicia that identifies the associated gas cylinder and distinguishes the gas cylinder from other gas cylinders being transported between the first and second location. The identification data may be transformed into a wireless signal that can be transmitted by the RFID device.

The identification data may be associated with location data 708 that provides the location of the gas cylinder. The location data may be provided by GPS electronics that are integrated into the RFID device or some other electronic component attached to (or in close proximity to) the gas cylinder. Alternatively, the location data may be provided by electronics that are part of a transport vehicle that is used to transport the gas cylinder. The identification data and location data may be associated by being combined into a single data set that is wirelessly transmitted by the RFID device. Alternatively, the identification data and the location data may be separately transmitted from the present location of the gas cylinder and associated at another location. Additional embodiments also include transmitting additional information about the gas cylinder, such as the type of gas stored in the cylinder, and the identification of the first and/or second locations, among other additional information.

The gas cylinder identification data and the location data may be communicated to a gas cylinder tracking system 710. The gas cylinder tracking system may be located at a site that is remote from both the first location and the second location, and may be used to track the progress of the gas cylinder from the first location to the second location. This tracking information may be communicated to the gas cylinder tracking system by a variety of electronic and/or telecommunications media including E-mail, cellular telephone, facsimile machine, pager device, the Internet, and private data communications networks, among other media. The tracking information may be transmitted in near continuous time to provide real-time or near real-time location information about the cylinder during the trip from the first location to the second location. The gas cylinder tracking system may also provide alerts when the gas cylinder is being routed to the wrong second location, or in transit to a wrong second location.

The second location may be an end-user's facility where the gas stored in the cylinder is consumed. The facility may be a research facility, and/or a manufacturing facility, among other types of facilities. The gas transported to the second location in the gas cylinder may be a specialty gas, an industrial gas, an electronic gas, and/or a gas used in analytical research, among other types of gases.

It should be appreciated that the method 700 may also be used to track a plurality of gas cylinders at the same time. For example, the method 700 may be used to track a plurality of gas cylinders held in close proximity to each other by a mobile cylinder carriage. The individual cylinders may be grouped together in the mobile cylinder carriage during transport from the first location to the second location, or they may be grouped together after arriving at either or both of these locations.

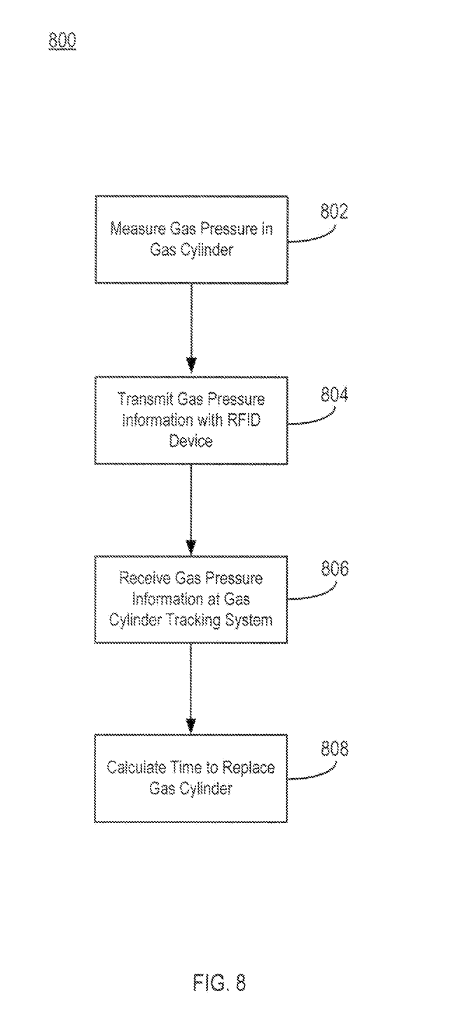

Referring now to FIG. 8, a flowchart showing selected steps in a method of determining inventory and usage of gas cylinders 800 according to embodiments of the invention is shown. The method 800 may include the step of measuring gas pressure in a gas cylinder 802. The measurement may be done by a sensor that is coupled to a cylinder valve on the gas cylinder. The method may further include the step of transmitting gas pressure information about the gas cylinder using an RFID device in electronic communication with the sensor 804. The RFID device may be integrated with the sensor as a single device on the gas cylinder, or it may be a separate device that is also attached to the gas cylinder or in close proximity to the gas cylinder. The same or different sensor coupled to the gas cylinder may also collect and produce additional information about the gas cylinder, such as the location of the cylinder, the downstream flowrate and pressure of gas exiting the cylinder, etc. This additional information may also be transmitted by the RFID device.

The information transmitted by the RFID device may be received at a gas cylinder tracking system 806. The tracking system may be located at the same location where the gas in the cylinder is being used, or at a remote location, or both. The gas cylinder tracking system can process the received information and calculate when the gas cylinder should be replaced 808. The tracking system may also be used to calculate the rate at which gas is being consumed at an end-user's facility and provide an estimate of the amount and frequency with which gas cylinders should be transported to the facility.

It should be appreciated that while the description of the steps in method 800 above focuses on a single cylinder, the method may also be used to determine inventory and usage of a plurality of cylinders. For example, the RFID device may transmit information from a plurality of cylinders being used in a process at an end-user's facility. The gas cylinders may be grouped in close proximity such as being contained in a mobile cylinder carriage. The plurality of gas cylinders may also be simultaneously supplying gas to an end use process, such that a portion of the cylinders can be replaced with new cylinders without having to interrupt or shut-down the entire process. The method 800 may include alerting process operators and/or the gas cylinder tracking system when one or more of the gas cylinders should be replaced on a manifold that fluidly connects a plurality of the gas cylinders to the end use process.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the cylinder” includes reference to one or more cylinders and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A gas cylinder transport cap comprising:
a bottom opening adapted for reversible attachment to a gas cylinder, wherein the attached cap surrounds a cylinder valve coupled to the gas cylinder;
a side surface which at least in part defines the perimeter of the bottom opening, wherein the side surface comprises a plurality of side openings; and
a top surface formed on an opposite side of the cap from the bottom surface, wherein the top surface comprises a top opening,
wherein the side openings and top opening improve transmissions of radio-frequency signals from a RFID device positioned inside the cylinder cap when the cap is attached to the gas cylinder.

2. The gas cylinder transport cap of claim 1, wherein the RFID device is attached to the cylinder valve coupled to the gas cylinder.

3. The gas cylinder transport cap of claim 1, wherein the RFID device is attached to an interior surface of the cap.

4. The gas cylinder transport cap of claim 1, wherein the plurality of side openings comprises two to four openings.

5. The gas cylinder transport cap of claim 1, wherein the side surface is cylindrically shaped and the top surface is dome shaped.

6. The gas cylinder transport cap of claim 5, wherein the plurality of side openings are equally spaced around the cylindrically shaped side surface.

7. The gas cylinder transport cap of claim 5, wherein the top opening is formed at an apex of the dome shaped top surface.

8. The gas cylinder transport cap of claim 1, wherein the RFID device is coupled to the cylinder valve and comprises a pressure sensor, wherein the RFID device is operable to measure and transmit a gas pressure in the gas cylinder.

9. The gas cylinder transport cap of claim 8, wherein the RFID device is connected to a recess port formed in the cylinder valve, wherein the recess port maintains a sealed latch between the RFID device and the cylinder valve.

10. The gas cylinder transport cap of claim 1, wherein the RFID device is attached to a flexible strap, and the flexible strap is attached to the transport cap or the cylinder valve.

11. A gas storage and monitoring system comprising:
a gas cylinder for storing the gas, wherein the gas cylinder comprises a cylinder valve;
a sensor fluidly coupled to the cylinder valve, wherein the sensor detects at least one measured characteristic of the gas cylinder and generates cylinder information; and
an RFID device in electronic communication with the sensor and operable to transmit a wireless signal comprising the cylinder information.

12. The system of claim 11, wherein the measured characteristic is a gas pressure in the cylinder.

13. The system of claim 11, wherein the wireless signal includes additional information selected from the group consisting of an identity of the gas cylinder, and a location for the gas cylinder.

14. The gas storage system of claim 11, wherein the system comprises a plurality of gas cylinder.

15. The gas storage system of claim 14, wherein each of the plurality of gas cylinders comprises the sensor.

16. The gas storage system of claim 14, wherein each of the plurality of the gas cylinders comprises the RFID device.

17. A method of tracking a gas cylinder transported between a first and second location, the method comprising:
coupling the gas cylinder to a RFID device;
loading the gas cylinder on a transportation vehicle;
reading a gas cylinder identification signal transmitted by the RFID device with an RFID signal reader that translates the signal into gas cylinder identification data;
associating the gas cylinder identification data with location data provided by a GPS device located in the transportation vehicle; and
communicating the gas cylinder identification data with the associated location data to gas cylinder tracking system that is remote from the transportation vehicle.

18. The method of claim 17, wherein the RFID device is located inside a gas cylinder transport cap that is reversibly attached to the gas cylinder.

19. The method of claim 17, wherein the gas cylinder identification data comprises a unique identifier for the gas cylinder and information about a type of gas stored in the gas cylinder.

20. The method of claim 19, wherein the gas cylinder identification data further comprises a gas pressure in the gas cylinder.

21. The method of claim 17, wherein the gas cylinder identification data with associated location data is communicated to the gas cylinder tracking system by e-mail, cellular telephone, a facsimile device, or a pager device.

22. The method of claim 17, wherein the first location is a gas producer facility and the second location is an end-user's facility.

23. The method of claim 17, wherein the gas cylinder tracking system is located at the gas producer facility.

24. The method of claim 23, wherein the gas cylinder identification data with the associated location data is communicated to the gas cylinder tracking system at discrete intervals or continuously.

25. The method of claim 17, wherein the gas cylinder is one of a plurality of gas cylinders loaded on the transportation vehicle.

26. A method of determining inventory and usage of gas cylinders, the method comprising the steps of:
measuring gas pressure in a gas cylinder with a sensor coupled to the gas cylinder;
transmitting gas pressure information about the gas cylinder using an RFID device in electronic communication with the sensor; and
receiving the gas pressure information at a gas cylinder tracking system, wherein the gas cylinder tracking system calculates a time when the gas cylinder should be replaced.
